(19) United States
(12) Patent Application Publication
(10) Pub. No.: US 2009/0168775 A1
(43) Pub. Date: Jul. 2, 2009

(54) HEURISTIC ALGORITHM FOR APPLICATION-LAYER MULTICAST WITH MINIMUM DELAY

(75) Inventors: Hwa-Chun LIN, Zhudong Town (TW); Yi-Lin Tsai, Yongkang City (TW)

Correspondence Address: STEIN MCEWEN, LLP, 1400 EYE STREET, NW, SUITE 300, WASHINGTON, DC, 20005, US

(73) Assignee: National Tsing Hua University of Taiwan, Republic of China

(21) Appl. No.: 12/143,175

(22) Filed: Jun. 20, 2008

(30) Foreign Application Priority Data
Dec. 31, 2007 (TW) 096151389

(51) Int. Cl. H04L 12/56

(52) U.S. Cl. 370/390

(57) ABSTRACT

A heuristic algorithm for calculating a multicast tree with minimum delay is disclosed. In the method, the time required for processing data at a transmitter, the time required for data transmission, and the time required for processing data at a receiver are taken into account. The time for transmitting data from a network terminal to other network terminals via an application-layer multicast is reduced when the present invention is utilized. Efficiency of the application-layer multicast is hence improved.

### FIELD OF THE INVENTION

The present invention relates to a heuristic algorithm for application-layer multicast, and more particularly to a heuristic algorithm for application-layer multicast with minimum delay.

### BACKGROUND OF THE INVENTION

Multicast is a very important to many network applications, such as web radio station, multi-party conferencing, VOIP, and so forth. However, IP multicast has its inherent limitation, e.g. the issues associated with network management and hardware deployment, making it less popular on the internet. Thus, many recent researches emphasize on the application-layer multicast, which moves the multicast function to the application layer and uses the traditional unicast network on the lower layer to form a logical network, that is, a so-called overlay network.

Unlike the traditional network-layer multicast in which multicast data are replicated in routers, the multicast data in an application-layer multicast are replicated in terminal equipments. Whereas, after moving multicast function to the application layer, efficiency thereof being degraded is inevitable in comparison with the network-layer multicast. Therefore, how to increase the efficiency and reduce the cost of application-layer multicast as much as possible is one of the major topics of related researches on application-layer multicast.

In the past, there were lots of researches and patents in association with application-layer multicast. For example, U.S. Pat. No. 7,200,654 published on Apr. 3, 2007 discloses a method for establishing and maintaining an overlay multicast tree. When a node is to be added to the current overlay multicast tree, a node on the current overlay multicast tree is selected based on the subnet ID, tree level and number of children and a new node is linked to the selected node. U.S. Pat. No. 7,194,549 published on Mar. 20, 2007 discloses a multicast method using clients to transmit data. U.S. Pat. No. 7,162,538 published on Jan. 9, 2007 discloses a software distribution method using client multicast. A final multicast tree is built by adding nodes to the current multicast tree one at a time from the source node.

Except the research made by Brosh et al., the researches of the prior arts on application-layer multicast did not take the processing delay or cost at each node into account. The paper by Brosh et al. (E. Brosh, A. Levin and Y. Shavitt, “Approximation and Heuristic Algorithms for Minimum-Delay Application-Layer Multicast Trees”, IEEE/ACM Transactions on Networking, vol. 15, pp. 473-484, 2007.) is the only one in which the processing delay or cost at each node is considered in application-layer multicast. When one node transmits data to multiple nodes, different transmission sequences will result in variation in overall delay. Therefore, Brosh et al. defined a sequential processing delay for each node in their cost model, and proposed a heuristic algorithm to find a multicast tree. The technique disclosed by Brosh et al. can still be improved to further reduce the multicast delay.

As such, the present invention discloses a new heuristic algorithm, which employs a greedy manner to establish the multicast tree to reduce the multicast delay. As compared with the method disclosed by Brosh et al., the present invention could further reduce the delay of the multicast tree (explained in details later).

The object of the present invention is to provide a heuristic algorithm for finding the applicast-layer multicast tree with a delay as low as possible so as to transmit data from a network terminal through a network to multiple other network terminals.

### SUMMARY OF THE INVENTION

The present invention provides a method for calculating a application-layer multicast tree with low delay comprising steps of:

a) initializing an overlay network (G), a multicast destination set (M), a source node (s), a processing delay (p(u)) for each node and a communication delay (c(u,v)) for a link of each pair of nodes;

b) setting the time obtained by adding the processing delay for a tree node (u) to the communication delay for a link between the tree node (u) and a destination node (v) as the cost from node u to node v, calculating all-pairs-shortest-path of the entire overlay network (G), calculating a shortest path cost (d(u,v)) from the tree node (u) to the destination node (v) and the node (π(u,v)) prior to the destination node (v) in a shortest path from the tree node (u) to the destination node (v);

c) selecting a node in the destination set (M) but not on the tree (T) and linking the node to the tree (T), and terminating calculation if the destination set (M) minus the set of nodes on the tree (T) is an empty set;

d) calculating the minimum possible delay for each destination node (v) not on the tree (T) to the tree (T), and then selecting a node with a minimum delay from the destination nodes not on the tree (T) to the tree (T), linking the selected node through the shortest path to the tree (T), and updating the delay of the tree (T); and

e) repeating the steps c) and d) until all destination nodes are on the tree (T).

In the present invention, the network model and cost definition used by Brosh et al. are used. However, the present invention further improves the MDM heuristic algorithm proposed by Brosh et al. A comparison between the method of present invention and method proposed by Brosh et al. is given as follow:

(1) The MDM heuristic algorithm proposed by Brosh et al. selects a node with maximum delay from nodes not on a tree and links it to the tree after calculating the minimum possible delay of each node not on the tree to the tree. The present invention selects a node from the nodes not on the tree with the minimum delay and links it to the tree;

(2) While calculating the minimum possible delay for each destination node (v) not on the tree (T) to the tree (T), the MDM heuristic algorithm proposed by Brosh et al. does not take the processing delay of each destination node (v) not on the tree (T) into account. The present invention takes the processing delay of each destination node (v) not on the tree (T) into account while calculating the minimum possible delay for each destination node (v) not on the tree (T) to the tree (T).

By utilizing the method of the present invention, data could be transmitted in an application-layer multicasting manner from a network terminal through intermediate networks to various other network terminals in a shorter time than the the MDM heuristic algorithm proposed by Brosh et al. The efficiency of application-layer multicast is hence enhanced.

The above objects and still other objects, characteristics and advantages will be apparent and best understood from the following description of specific embodiments when read in connection with the accompanying drawings.

### BRIEF DESCRIPTION OF THE DRAWINGS

FIG. 1 is a flow chart showing the calculation of an application-layer multicast tree according to the present invention;

FIG. 2 is a graph showing the comparison of the average delays of the multicast trees obtained using the present invention and the prior art when the overall network nodes are in a range of 10˜100; and

FIG. 3 is a graph showing the comparison of the average delays of the multicast trees obtained using the present invention and the prior art when the overall network nodes are in a range of 100˜1000.

### DETAILED DESCRIPTION OF THE PREFERRED EMBODIMENT

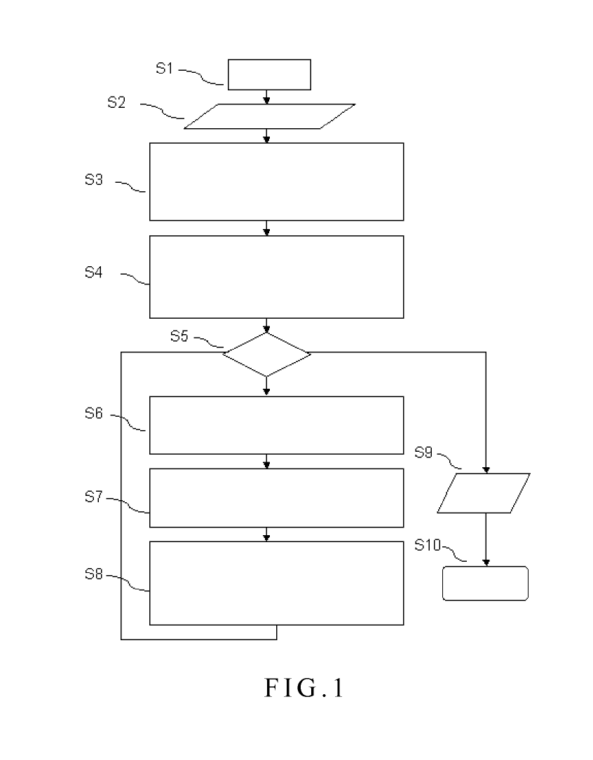

FIG. 1 is a flow chart showing the calculation of an application-layer multicast tree according to the present invention. Prior to detailed description of the flow chart, definitions of the following terms are given.

The term “overlay network” is defined as a connected directed graph G=(V,E), consisting of two sets: a set of vertices V and a set of edges E in the overlay network in which V(G) and E(G) represent a set of network terminal nodes and a set of links among the nodes in the overlay network respectively. Each link, (u,v) ε E, is associated with a communication delay c(u,v). Each node, v ε V, is associated with a processing delay p(v). The communication process for sending a piece of data from node u to node v through link (u, v) is described as follows: Suppose that node u starts the communication process at time t. Node u consumes a time period of p(u) to process the data during the time interval [t,t+p(u)]. After node u finishes processing the data, a time period of c(u,v) is required to transmit the data to the v. In other words, the data will reach node v at time t+p(u)+c(u,v). Node u is ready to begin another communication process at time t+p(u).

The term “processing delay” can be interpreted as the time period required for processing data at a node and for transmitting the data to a network device. As a network terminal node usually has only one network interface card, a node is not able to simultaneously transmit data to several different destination nodes at its highest speed. If each node transmits the data at the highest speed, it is necessary to transmit the data sequencially in order to transmit the data to two or more destination nodes. In the present invention, it is assumed that each node always transmits data at its highest speed. Hence, one node can only process and transmit one datum at any time instance.

The term “communication delay” can be interpreted as the time period required for transmitting the data in the network until the data is received by the destination node. Due to the large transmission bandwidth of the backbone network, it is assumed that multiple copies of the data can be simultaneously transmitted to multiple destination nodes through the network.

The term “multicast tree” is defined as a tree (denoted by T) composed of a source node s, nodes in the destination set M, and possibly some of the nodes in the set V(G)-M as intermediate nodes. The term “delay of a multicast tree” is defined as the time period starting from a time instance at which the source node starts processing and transmitting the data until a time instance at which all of the nodes in the destination set M receive the data.

With reference to FIG. 1, in steps S1 and S2, a topology G=(V,E) of an overlay network, a set of destination nodes M, a source node s, a processing delay p(u) associated with each node u and a communication delay c(u,v) associated with each link (u, v) are initialized. Then, a greedy method is applied to establish a multicast tree. Using p(u)+c(u,v) as the cost of transmission from node u to node v, calculate all-pairs-shortest-path of the entire overlay network (step S3). The result of the calculation for the all-pairs-shortest-path includes two arrays, in which one array represents the shortest path cost d(u,v) from node u to node v, and the other array represents the node π(u,v) prior to node v on the shortest path from node u to node v (step S4).

Subsequently, the node s is used as the root of a tree T. In each iteration, the condition that whether the destination set M minus the set V(T) of nodes on the tree T is an empty set is use to determine whether to terminate the calculation or not (step S5). If M−V(T) is not an empty set, a node in the destination set M but not on the tree T is selected and linked to the tree T (step S6). The criterion for selecting the node will be described later. The calculation is terminated if M−V(T) is an empty set (steps S9 and S10). For each node u on the tree T, the time instance at which node u is is ready to process and transmit data to another node is defined as the ready time at node u represented by t(u). For each destination node v not on the tree, a minimum delay t(u)+d(u,v)+p(v) is calculated in each iteration (step S6). A node with the lowest delay is selected from the destination nodes not on the tree and linked to the tree T via the shortest path (step S7). The delay of the tree T and the ready times of the nodes on the tree are updated (step S8). Steps S5-S8 are repeated until all destination nodes are on the tree T. As such, when the present invention is utilized, a multicast tree could be found and data could be multicasted from the source node s to all the nodes in the destination set M.

In order to demonstrate that the method of the present invention could further reduce the delay of the multicast tree, a computer simulation for comparison between the method of the present invention and the MDM heuristic algorithm proposed by Brosh et al. is made. In the simulation, a ratio setting of the number of nodes with public IP addresses to the number of nodes with private IP addresses node is added. The effect of the types of IP addresses on network topology is as follows. There is link from each node to every other node with a public IP address. There is no link from a node with private IP address to any other node with a private IP address.

In the simulation, the values of the parameters used are as follows:
(i) the number of nodes |V| ranges from 10 to 1000 and the number of destination nodes |M| equals the number of node |V|;
(ii) for each node v, where v ε V, the processing delay p(v) of node v is a real number selected randomly in the range of 0.5˜1.5;
(iii) for each link (u, v), where (u,v) ε E, the communication delay c(u,v) is a real number selected randomly in the range of 0.5˜1.5;
(iv) the ratio of the number of nodes with public IP addresses to the number of nodes with private IP addresses is 7:3.

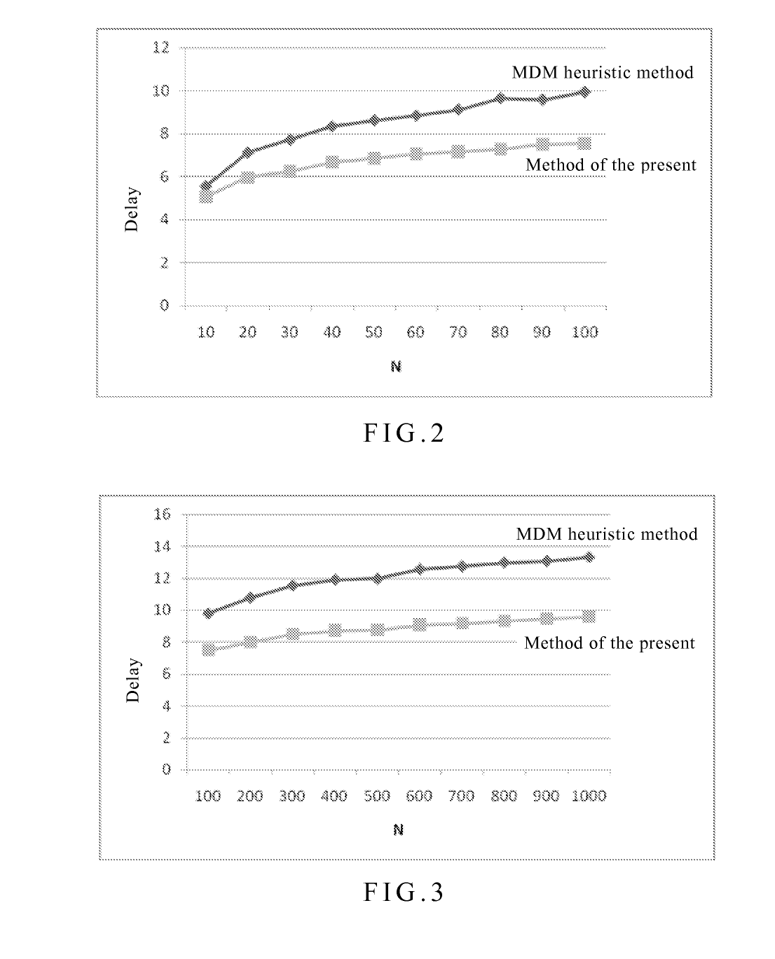

Each data point in the graphs (FIG. 2 and FIG. 3) is obtained by the following method: randomly generating 100 different topologies with the same parameter configuration; building multicast trees using the MDM heuristic method and the method of the present invention respectively and calculating the delay for each multicast tree; and finally calculating the average delay of the 100 multicast trees. FIG. 2 shows the average delays of the multicast trees when the number of nodes in the entire network is in a range of 10˜100, and FIG. 3 shows the average delays of the multicast trees when the number of nodes in the entire network is in a range of 100˜1000. From FIG. 2 and FIG. 3 the average delays of the multicast trees generated by the method of the present invention is significantly lower than those generated by the MDM heuristic method. The method of the present invention could effectively reduce the delay of the multicast tree.

While this invention has been described in reference to a preferred embodiment, it should be understood that numerous changes and modifications could be made within the spirit and scope of the inventive concepts described. Accordingly, it is intended that the invention shall not be limited to the disclosed embodiment but have the full scope permitted by the language of the following claims.

1. A method for calculating application-layer multicast tree with low delay, comprising steps of:
a) initializing an overlay network (G), a multicast destination set (M), a source node(s), a processing delay (p(u)) for each node u and a communication delay (c(u,v)) for each link (u, v);
b) setting a time obtained by adding the processing delay for a tree node (u) to the communication delay for a link between the tree node (u) and a destination node (v) as the cost from the tree node u to the destination node v, calculating all-pairs-shortest-path of the entire overlay network (G), and calculating a shortest path cost (d(u,v)) from the tree node (u) to the destination node (v) and the node (π(u,v)) prior to the destination node (v) on a shortest path from the tree node (u) to the destination node (v);
c) selecting a node in the destination set (M) but not on the tree (T) and linking the node in the destination set (M) but not on the tree (T) to the tree (T); and terminating calculation if the destination set (M) minus the set of nodes on the tree (T) is an empty set;
d) calculating a minimum possible delay t(u)+d(u,v)+p(v) for each destination node (v) not on the tree (T) to the current tree (T), and then selecting a node with a minimum delay from destination nodes not on the tree (T), linking the node with the minimum delay to the tree (T) through the shortest path, and updating the ready time t(u) of each of the nodes on the tree (T); and
e) repeating the steps c) and d) until all destination nodes are all on the tree (T).

2. The method as claimed in claim 1, wherein the minimum possible delay comprises a ready time (t(u)) of the tree node (u), a time (d(u,v))(p(v)) required for transmitting data through the shortest path from the tree node (u) to the destination node (v) and the processing delay for the destination node (v).
